(19) United States
(12) Patent Application Publication
(10) Pub. No.: US 2019/0135136 A1
(43) Pub. Date: May 9, 2019

(54) VEHICLE SEAT STRUCTURE

(71) Applicant: TOYOTA BOSHOKU KABUSHIKI KAISHA, Aichi-ken (JP)

(72) Inventors: Fumitoshi AKAIKE, Aichi-ken (JP); Hiroshi TSUJI, Aichi-ken (JP)

(73) Assignee: TOYOTA BOSHOKU KABUSHIKI KAISHA, Aichi-ken (JP)

(21) Appl. No.: 16/179,091

(22) Filed: Nov. 2, 2018

(30) Foreign Application Priority Data
Nov. 9, 2017 (JP) 2017-216143

(51) Int. Cl. B60N 2/01; B60N 2/30; B60N 2/32

(52) U.S. Cl. CPC B60N 2/01; B60N 2/32; B60N 2/3047

(57) ABSTRACT

A vehicle seat structure including: a mode switching mechanism configured to switch configurations of two seats arranged in a front-rear direction between a face-to-face mode in which seated occupants are seated on the seats to face each other in the front-rear direction and a non-face-to-face mode in which the face-to-face mode is released, wherein one seat of the two seats is a wall seat attached to a wall of a vehicle which faces another seat of the two seats in the front-rear direction, and is configured to be switched, by the mode switching mechanism, between the non-face-to-face mode in which a seat surface portion of the one seat is accommodated in a concave portion in the wall and the face-to-face mode in which the seat surface portion of the one seat is pulled out from the concave portion so as to be capable of being seated on.

### CROSS-REFERENCE TO RELATED APPLICATIONS

This application claims priority from Japanese Patent Application No. 2017-216143 filed on Nov. 9, 2017, the entire contents of which are incorporated herein by reference.

### TECHNICAL FIELD

The present disclosure relates to a vehicle seat structure, specifically to a vehicle seat structure including a mode switching mechanism that switches configurations of two seats arranged in a front-rear direction between a face-to-face mode in which seated occupants are seated on the seats to face each other in the front-rear direction and a non-face-to-face mode in which the face-to-face mode is released.

### BACKGROUND

There is known a vehicle seat structure which can be switched to a mode in which a front seat in a vehicle interior is switched rearward to face a rear seat (JP-A-2017-24653).

In the above related technology, the seat which can be switched to the face-to-face mode is remained in the vehicle interior even when the face-to-face mode is released. Accordingly, a wide space in the vehicle interior cannot be ensured when the vehicle seat structure is not in the face-to-face mode.

### SUMMARY

An object of the present disclosure is, in a vehicle seat structure which can be switched to a face-to-face mode, to widen interior space of a vehicle when the vehicle seat structure is not in the face-to-face mode.

An aspect of the disclosure provides a vehicle seat structure including a mode switching mechanism configured to switch configurations of two seats arranged in a front-rear direction between a face-to-face mode in which seated occupants are seated on the seats to face each other in the front-rear direction and a non-face-to-face mode in which the face-to-face mode is released, wherein one seat of the two seats is a wall seat attached to a wall of a vehicle which faces another seat of the two seats in the front-rear direction, and is configured to be switched, by the mode switching mechanism, between the non-face-to-face mode in which a seat surface portion of the one seat is accommodated in a concave portion in the wall and the face-to-face mode in which the seat surface portion of the one seat is pulled out from the concave portion so as to be capable of being seated on.

According to the aspect of the disclosure, the one seat that constitutes the face-to-face mode is the wall seat attached to the wall of the vehicle, and the seat surface portion of the same wall seat is accommodated in the concave portion of the wall by the mode switching mechanism when the one seat is in the non-face-to-face mode. Therefore, the interior space can be widened when the one seat is not in the face-to-face mode.

### BRIEF DESCRIPTION OF DRAWINGS

FIG. 1 is a perspective view illustrating a schematic configuration of a vehicle seat structure according to a first embodiment;

FIG. 2 is a rear perspective view of FIG. 1;

FIG. 3 is a perspective view illustrating a state in which an instrument panel seat is unfolded and switched to a face-to-face mode;

FIG. 4 is a rear perspective view of FIG. 3;

FIG. 5 is a perspective view illustrating a state in which a seat surface portion of the instrument panel seat is used as a heel rest;

FIG. 6 is a perspective view illustrating a state in which a seat surface portion of the instrument panel seat is used as a sole rest;

FIG. 7 is a side view illustrating an accommodated state of the instrument panel seat;

FIG. 8 is a side view illustrating a non-accommodated state of the instrument panel seat;

FIG. 9 is a side view illustrating switching operation of a seat surface angle when the instrument panel seat is in the non-accommodated state;

FIG. 10 is a side view illustrating a movable path of the instrument panel seat; and

FIG. 11 is a perspective view illustrating a schematic configuration of a vehicle seat structure according to a second embodiment.

### DETAILED DESCRIPTION

Hereinafter, modes for carrying out the present disclosure are described with reference to drawings.

### First Embodiment

General Configuration of Seat Structure 1

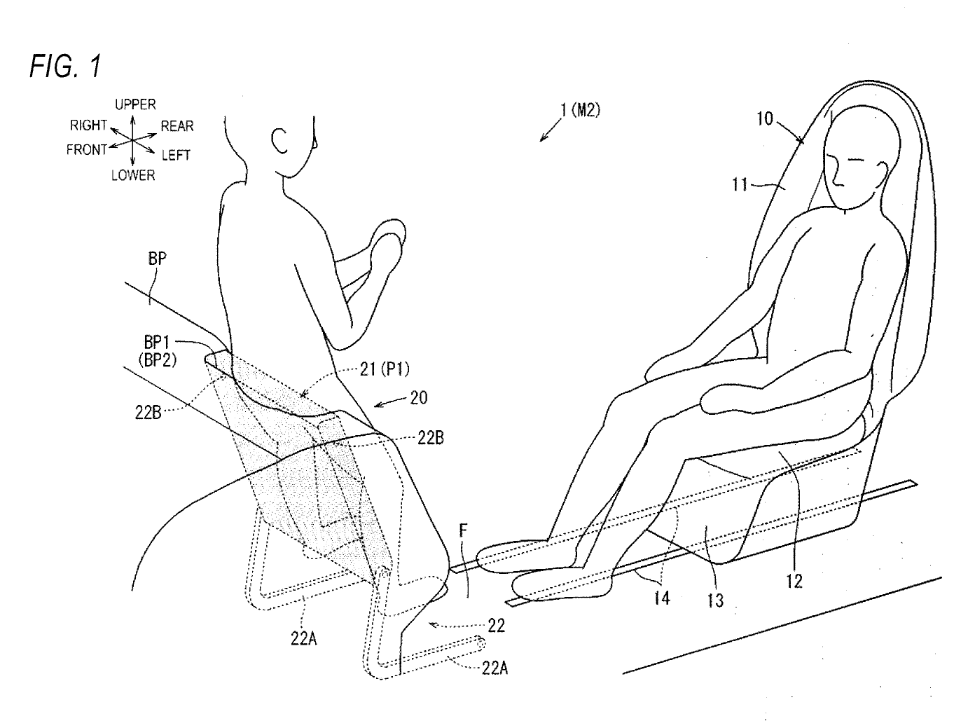

First, a seat structure 1 (vehicle seat structure) according to a first embodiment is described with reference to FIGS. 1 to 10. In the following description, directions such as front, rear, upper, lower, left and right directions refer to those respectively illustrated in the drawings. A “seat width direction” refers to a left-right direction of a seat 10 to be described below.

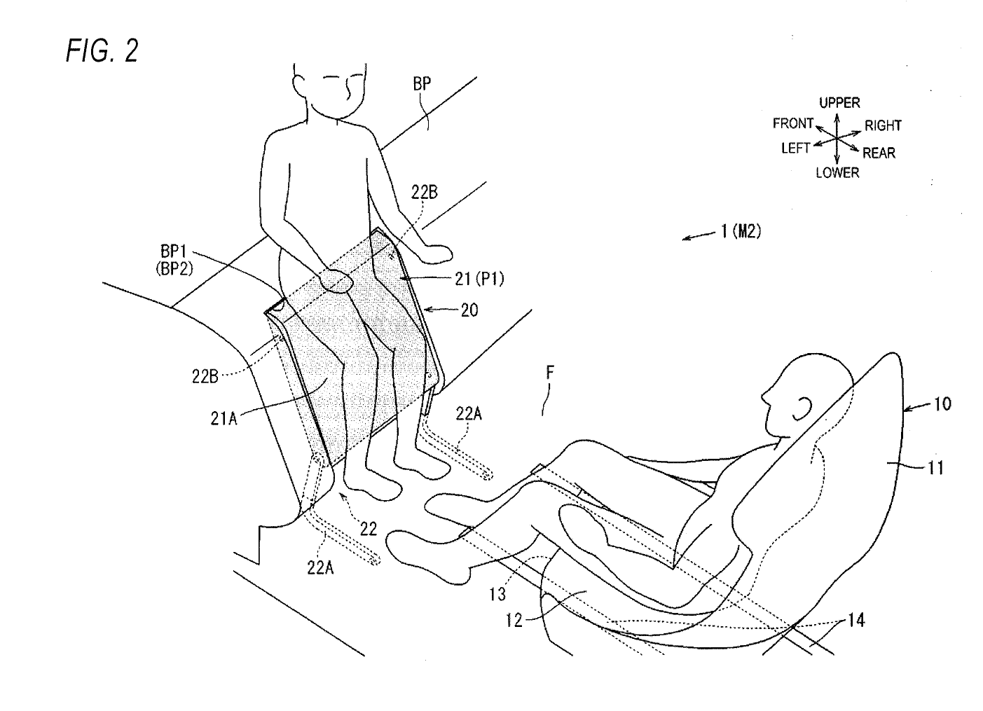

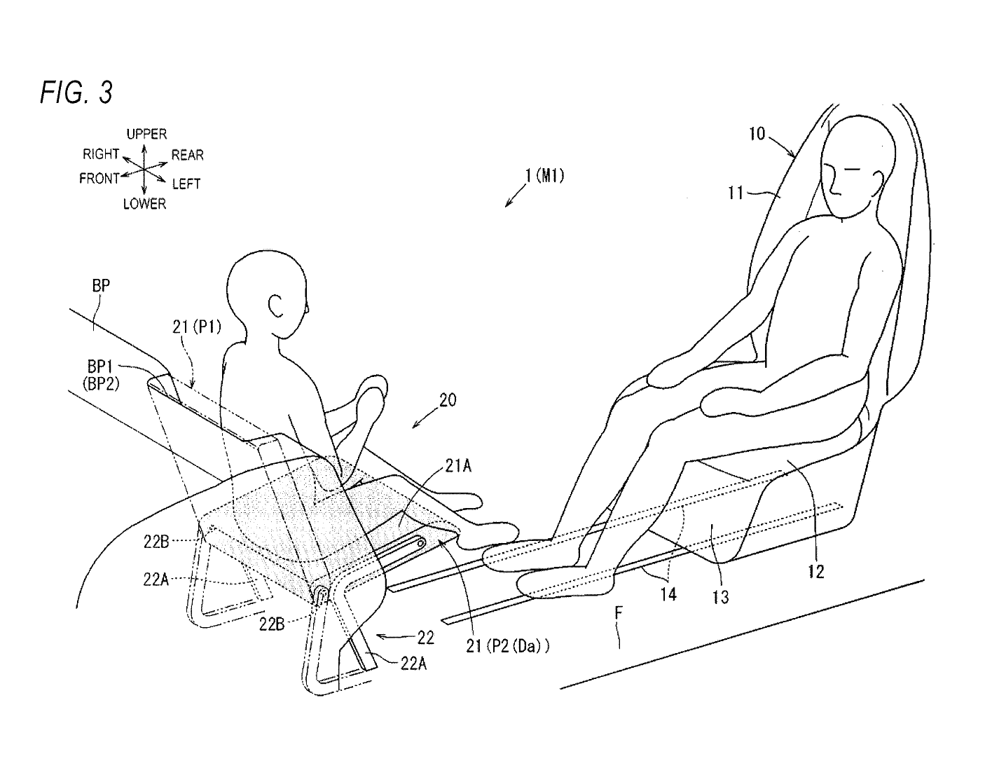

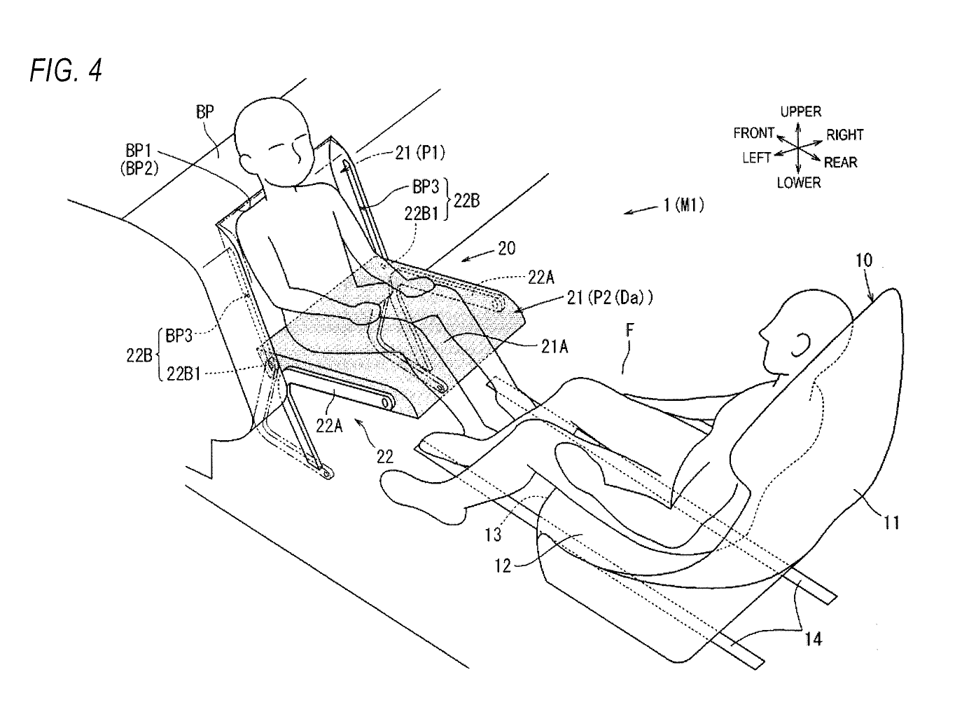

As illustrated in FIGS. 1 to 4, the seat structure 1 according to this embodiment includes a switching mechanism 22 between the seat 10 as a front seat of an automobile and an instrument panel BP constituting a front wall of a vehicle interior in front of the seat 10. The switching mechanism 22 allows occupants to be seated facing each other in a front-rear direction (see FIGS. 3 and 4), and allows an occupant on the instrument panel BP side to lean on the instrument panel BP in an upright posture (see FIGS. 1 and 2). The instrument panel BP corresponds to a “wall” of the present disclosure, and the switching mechanism 22 corresponds to a “mode switching mechanism” of the present disclosure.

Specifically, the switching mechanism 22 includes, on a portion of the instrument panel BP which faces the seat 10 from front, an instrument panel seat 20 including a seat surface portion 21, in which the seat surface portion 21 is switchable between a vertical posture P1 allowing an occupant to lean with his/her hip in an upright posture (see FIGS. 1 and 2) and a horizontal posture P2 in which the occupant inclines the hip to a seated state (see FIGS. 3 and 4). Accordingly, the switching mechanism 22 is switched between a face-to-face mode M1 (see FIGS. 3 and 4) in which the occupants are seated facing each other in the front-rear direction and a non-face-to-face mode M2 in which the occupant on the instrument panel BP side, who is facing the other occupant in the front-rear direction, leans on the instrument panel in an upright posture (see FIGS. 1 and 2). The instrument panel seat 20 corresponds to “one seat” and a “wall seat” of the present disclosure, and the seat 10 corresponds to “another seat” of the present disclosure.

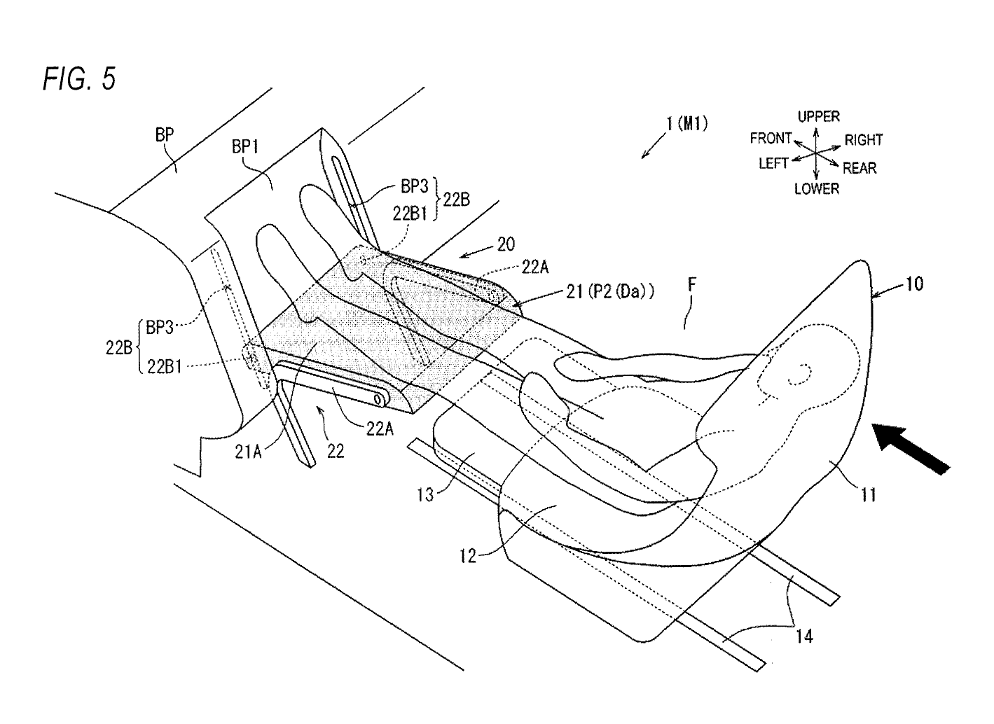

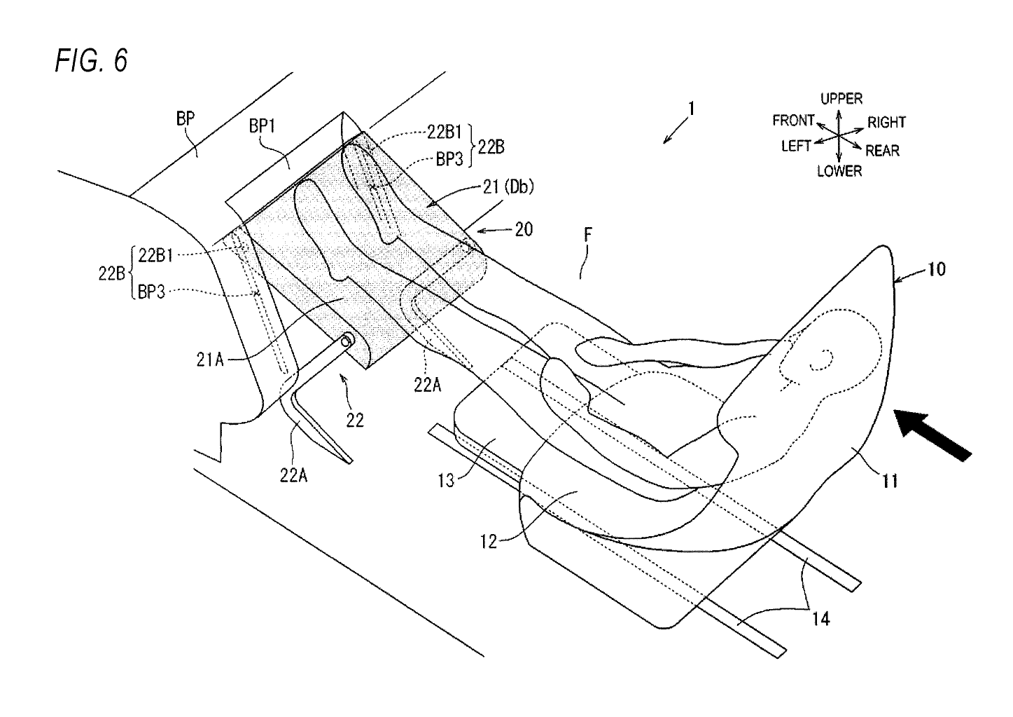

The seat 10 as the front seat is on a vehicle floor F and faces vehicle front. The seat 10 includes a seat back 11 serving as a backrest portion of a seated occupant, a seat cushion 12 serving as a seating portion, an ottoman 13 serving as a footrest portion, and a slide mechanism 14 that adjusts a seated position in the front-rear direction on the vehicle floor F. The seat 10 configured as above is switched between a state in which the occupant is seated in a normal seated posture, as illustrated in FIGS. 1 to 4, and a state in which the occupant takes a relaxed posture of inclining his/her body rearward and throws feet forward by inclining the seat back 11 rearward and unfolding the ottoman 13 forward, as illustrated in FIGS. 5 and 6.

As illustrated in FIGS. 1 to 4, since the seated position is adjusted in the front-rear direction on the vehicle floor F, the seat 10 is appropriately adjusted to move toward or away from the instrument panel BP in the front-rear direction. Specific configurations of the ottoman 13 and the slide rail are substantially the same as those disclosed in JP-A-2016-133138 or JP-A-2017-121905, and detailed descriptions are omitted here.

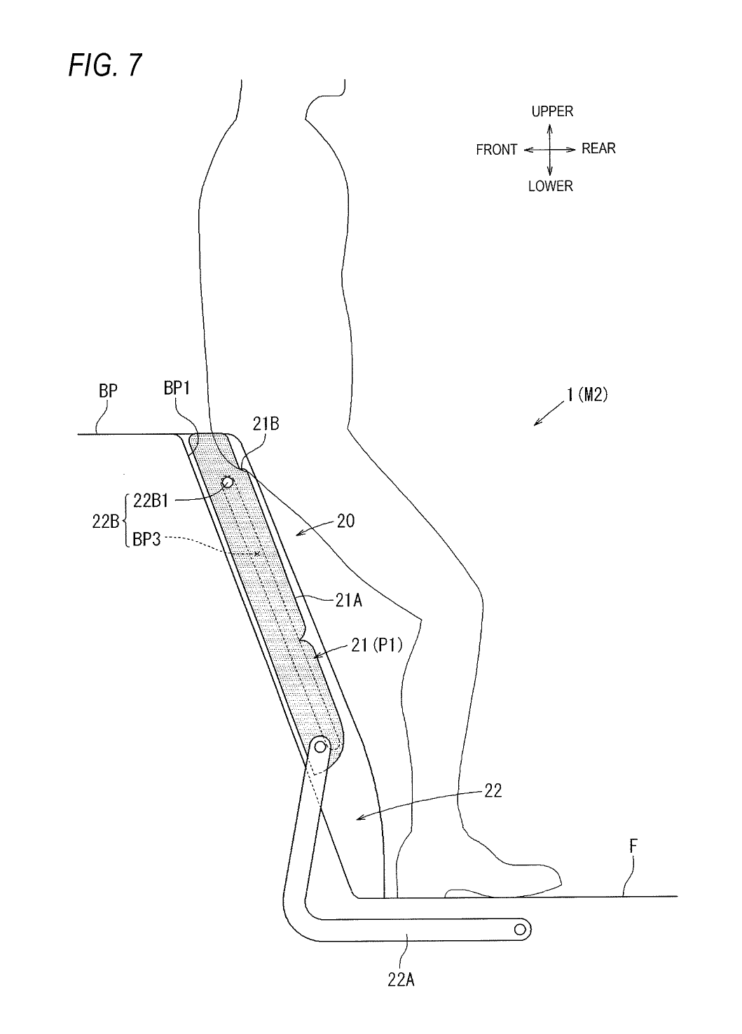

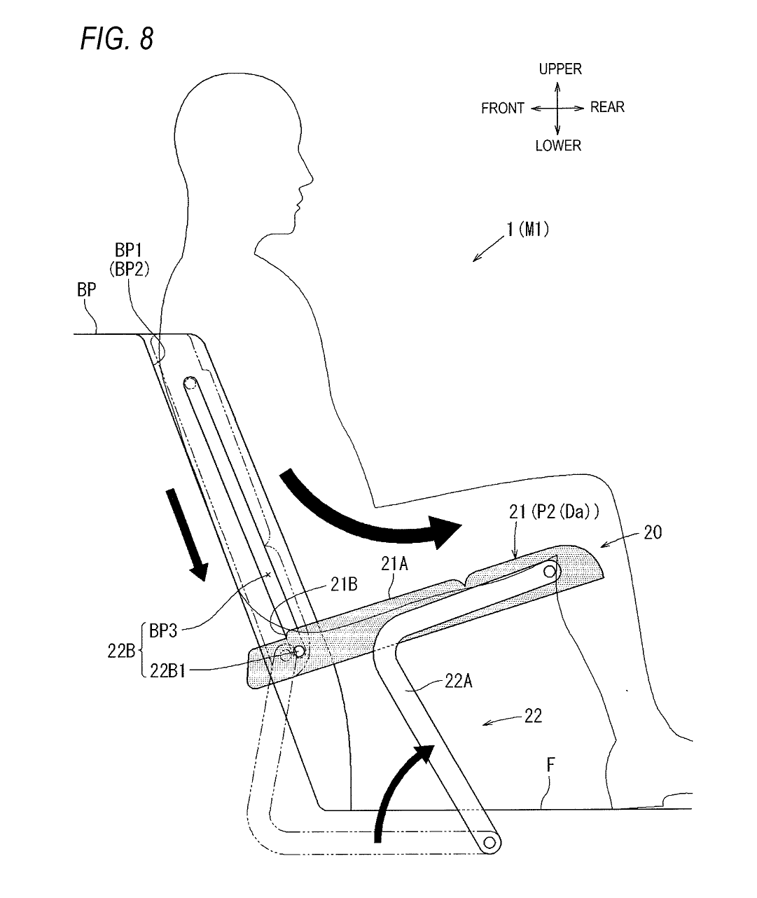

The instrument panel seat 20 includes (i) the seat surface portion 21 in a concave portion BP1 of the instrument panel BP and (ii) the switching mechanism 22 that allows the seat surface portion 21 to be switched between the vertical posture P1 in which the seat surface portion 21 is accommodated in the concave portion BP1 to be flush with the instrument panel BP, as illustrated in FIGS. 2 and 7, and the horizontal posture P2 in which the seat surface portion 21 falls down in a form of being slid rearward such that the surface thereof faces upwards, as illustrated in FIGS. 4 and 8.

The seat surface portion 21 is a plate-like member including a substantially rectangular seating surface 21A. Specifically, a substantial frame of the seat surface portion 21 is formed by a resin panel member, and a pad member (not illustrated) having cushioning properties and a cover member (not illustrated) forming a design surface are stacked on a surface of the seat surface portion 21 on the seating surface 21A side.

When the seat surface portion 21 is in the vertical posture P1 of being accommodated in the concave portion BP1, as illustrated in FIGS. 2 and 7, the seating surface 21A faces the rear direction and is substantially flush with a general surface of the surrounding instrument panel BP. Specifically, when the seat surface portion 21 is in the vertical posture P1, the seating surface 21A serves as a forward inclined surface inclined slightly upward and supports the hip of the occupant from obliquely below when the occupant leans with the hip in an upright posture.

The seating surface 21A includes a step surface 21B in a height direction thereof. The step surface 21B serves as a partial stepped upward surface so as to support the hip of the occupant from directly below and prevent displacement when the seat surface portion 21 is in the vertical posture P1. The step surface 21B supports the occupant stably without displacement from below even the occupant leans with the hip in an upright posture in a manner of sinking the hip from obliquely above the seating surface 21A which is in an erected form.

When the seat surface portion 21 is in the horizontal posture P2 of being inclined in a form of protruding rearward from the concave portion BP1, as illustrated in FIGS. 4 and 8, the seating surface 21A faces an upper direction for the occupant to sink the hip and sit on the seating surface 21A. Specifically, when the seat surface portion 21 is in the horizontal posture P2, the seating surface 21A is set to an angle Da at which a forward inclined surface is formed, so as to support thighs of the occupant seated on the seating surface 21A from below in a comfortable manner of being obliquely raised.

Further, by being switched to the horizontal posture P2 as described above, the seat surface portion 21 is used as a footrest on which heels of the feet are placed when the occupant seated on the opposite seat 10 takes a relaxed posture as illustrated in FIG. 5. Specifically, when the seat surface portion 21 is switched to the horizontal posture P2, the upper seating surface 21A is set to the angle Da at which the forward inclined surface is formed, so that the heels of the occupant, who is taking a relaxed posture in which the feet are placed on the ottoman 13 of the opposite seat 10, is placed at a comfortable angle on the seating surface 21A of the seat surface portion 21 which is set to the angle Da at which the forward inclined surface is formed.

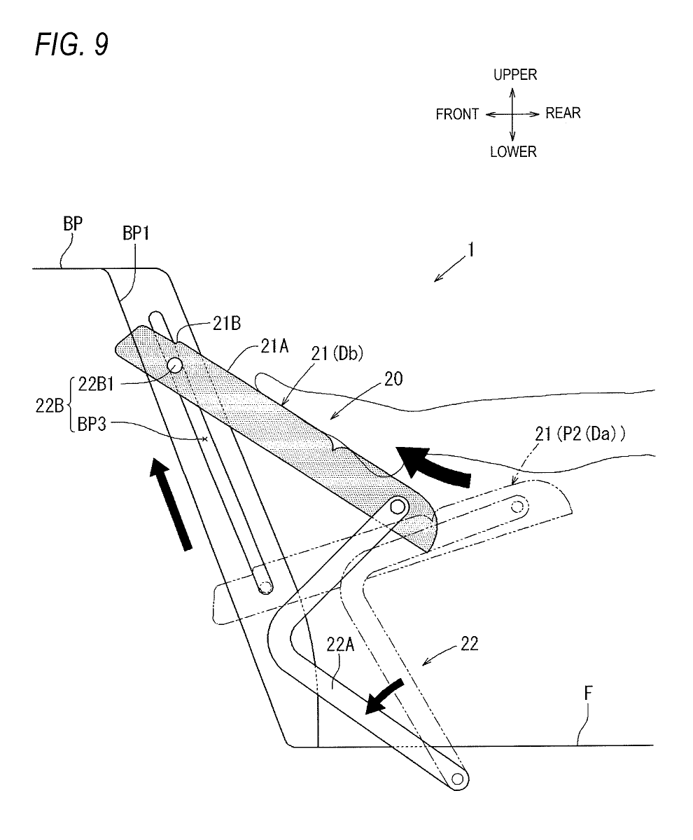

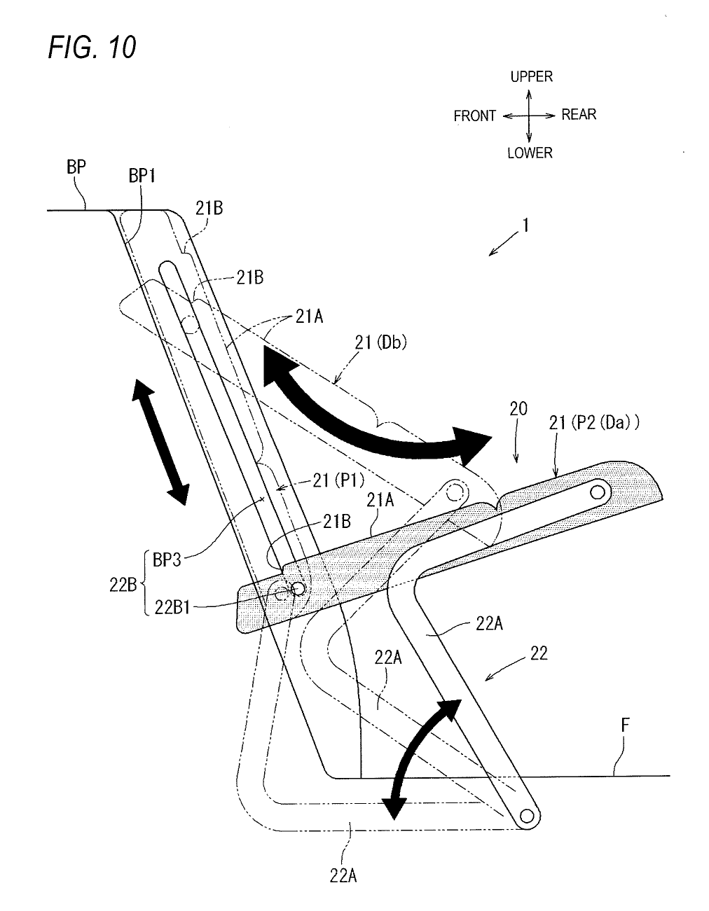

Further, in an operation path of being switched between the vertical posture P1 and the horizontal posture P2 as illustrated in FIG. 10, the seat surface portion 21 is set to an angle Db, at which a rearward inclined surface is formed, at a position lower than the seating surface 21A in the vertical posture P1 and higher than the seating surface 21A in the horizontal posture P2 by an operation structure of the switching mechanism 22 to be described below, as illustrated in FIG. 9. Accordingly, as illustrated in FIG. 6, when the occupant seated on the opposite seat 10 takes a relaxed posture, the seat surface portion 21 functions to abut soles of the occupant against the seating surface 21A of the seat surface portion 21, which is set to the angle Db at which the rear inclined surface is formed, at a comfortable angle.

With the configuration through which the angle is adjusted, a seat surface angle when the occupant is seated on the seating surface 21A of the seat surface portion 21 or a footrest angle when the seat surface portion 21 is used as a footrest is adjusted to an appropriate angle. A position of the opposite seat 10 in the front-rear direction when the seat surface portion 21 is used as a footrest is appropriately adjusted by the slide mechanism 14 on the same seat 10. The switching mechanism 22 corresponds to a “seat surface angle adjusting mechanism” of the present disclosure.

As illustrated in FIGS. 7 to 10, the switching mechanism 22 includes a pair of left and right L-shaped links 22A that connects the seat surface portion 21 and the vehicle floor surface F and a pair of left and right slide connection mechanisms 22B that connects the seat surface portion 21, in a manner of being slidable in the height direction, to both left and right side surfaces in the concave portion BP1 of the instrument panel BP. Via drive control by an electric unit (not illustrated) connected to the L-shaped links 22A, the switching mechanism 22 moves the seat surface portion 21 to an appropriate position between the vertical posture P1 as illustrated in FIG. 7 and the horizontal posture P2 illustrated in FIG. 8 and stops the seat surface portion 21 at the position.

Specifically, the L-shaped links 22A are connected to lower end positions on both left and right side surfaces of the seat surface portion 21 in the vertical posture P1 as illustrated in FIG. 7 and positions on the vehicle floor surface F on rear lower sides of the lower end positions, respectively. The L-shaped links 22A have a substantially L shape in a side view when the seat surface portion 21 is in the vertical posture P1 as illustrated in FIG. 7, and have a detour shape bent forward and downward with less protrusion to foot space to the instrument panel BP. As illustrated in FIG. 8, the L-shaped links 22A are moved such that connection points between the L-shaped links 22A and the vehicle floor surface F are pulled out rearward greatly by being rotated rearward about connection points between the L-shaped links 22A and the vehicle floor surface F. Therefore, the seat surface portion 21 is switched to the horizontal posture P2 from the vertical posture P1.

The slide connection mechanisms 22B respectively include slide pins 22B1 projecting outward in a seat width direction from upper end side positions on the both left and right side surfaces of the seat surface portion 21 in the vertical posture P1 as illustrated in FIG. 7, and long holes BP3 extending straight in the height direction in the both left and right side surfaces of the concave portion BP1 of the instrument panel BP, the long holes BP3 allowing the slide pins 22B1 to slide in the height direction in the long holes BP3. In the slide connection mechanisms 22B, the slide pins 22B1 are located in vicinity of upper ends of the long holes BP3 when the seat surface portion 21 is in the vertical posture P1 as illustrated in FIG. 7.

Since the seat surface portion 21 is pulled out rearward by rotation of the L-shaped links 22A, as illustrated in FIG. 8, the slide connection mechanisms 22B are moved in such a manner that the slide pins 22B1 are allowed to slide downward along the long holes BP3 and a height position of the seat surface portion 21 is lowered. When the seat surface portion 21 is switched to the horizontal posture P2, the slide connection mechanisms 22B are respectively located at the lower ends of the long holes BP3. At this location, even when loads are input from above as the occupant is seated on the seat surface portion 21, the slide connection mechanisms 22B receive the loads powerfully via support received by abutting the slide pins 22B1 to the lower ends of the long holes BP3.

Specifically, as illustrated in FIG. 10, the switching mechanism 22 moves, via operation of switching the seat surface portion 21 in the vertical posture P1 to the horizontal posture P2, the seating surface 21 in such a manner that the seating surface 21A is pulled out rearward so as to face upward while being gradually sunk to a lower position corresponding to a seated posture from a state of facing the rear direction at a higher position corresponding to an upright posture. With such a configuration, when the occupant, who is leaning the hip in an upright posture on the seating surface 21A of the seat surface portion 21 in the vertical posture P1, switches the seat surface portion 21 from the vertical posture P1 to the horizontal posture P2, the seat surface portion 21 is switched from the vertical posture P1 to the horizontal posture P2 with the hip leant on the seat surface portion 21 without being separated.

Specifically, via the operation of switching the seat surface portion 21 from the vertical posture P1 to the horizontal posture P2, the seating surface 21A is gradually pulled out rearward so as to face upward from the state of facing the rear direction. Therefore, the occupant, who is leaning the hip in an upright posture on the seating surface 21A of the seat surface portion 21 in the vertical posture P1, is switched to a state of being supported from below by the seating surface 21A while gradually sinking downward as the seat surface portion 21 is moved to the horizontal posture P2, and is switched to a state of being seated on the seating surface 21A of the seat surface portion 21 in the horizontal posture P2.

As shown in FIG. 8, since the seat surface portion 21 is switched to the horizontal posture P2, a recessed inner surface of the concave portion BP1 of the instrument panel BP that accommodates the seat surface portion 21 functions as a backrest surface BP2 facing the rear direction that rises obliquely forward and upward from the front end of the seat surface portion 21 in the horizontal posture P2. Therefore, the back of the occupant seated on the seat surface portion 21 is leant on the backrest surface BP2. Since the back of the occupant is leant on the backrest surface BP2, the body of the occupant is supported with both sides thereof being wrapped by a recessed shape of the concave portion BP 1.

### SUMMARY

To summarize the above, the seat structure 1 of this embodiment has the following structure. That is, the seat structure (1) includes a mode switching mechanism (22) configured to switch configurations of two seats (10, 20) arranged in a front-rear direction between a face-to-face mode (M1) in which seated occupants are seated on the seats to face each other in the front-rear direction and a non-face-to-face mode (M2) in which the face-to-face mode (M1) is released. One seat (20) of the seats (10, 20) is a wall seat attached to a wall (BP) of a vehicle which faces another seat (10) of the two seats in the front-rear direction, and is switched, by the mode switching mechanism (22), between the non-face-to-face mode (M2) in which a seat surface portion (21) of the one seat (20) is accommodated in a concave portion (BP1) in the wall (BP) and the face-to-face mode (M1) in which the seat surface portion (21) of the one seat (20) is pulled out from the concave portion (BP1) so as to be capable of being seated on.

In this way, the one seat (20) that constitutes the face-to-face mode (M1) is the wall seat attached to the wall (BP) of the vehicle, and the seat surface portion (21) of the same wall seat (20) is accommodated in the concave portion (BP1) of the wall (BP) by the mode switching mechanism (22) when the one seat (20) is in the non-face-to-face mode (M2). Therefore, the interior space can be widened when the one seat (20) is not in the face-to-face mode (M1).

The vehicle seat structure (1) further includes a slide mechanism (14) that configured to adjust a position of the other seat (10) relative to a vehicle body (F) in the front-rear direction. With such a configuration, a face-to-face distance between the wall seat (20) and the other seat (10) can be appropriately adjusted by the slide mechanism (14). Besides, the other seat (10) can be brought close to the wall seat (20) to expand a function of using the seat surface portion (21) of the wall seat (20) as a footrest.

The vehicle seat structure (1) further includes a seat surface angle adjusting mechanism (22) configured to switch a seat surface angle of the seat surface portion (21) of the one seat (20) in the face-to-face mode (M1) to an angle (Da) at which a forward inclined surface is formed and an angle (Db) at which a rearward inclined surface is formed. With such a configuration, the seat surface angle of the seat surface portion (21) in the face-to-face mode (M1) can be adjusted by the seat surface angle adjusting mechanism (22). Besides, in a case in which the seat surface portion (21) is used as the footrest, the seat surface angle can be switched, as an expanded function, between an inclined surface angle (Da) inclined toward one side appropriate for placing soles and an inclined surface angle (Db) inclined to another side appropriate for placing heels.

In the non-face-to-face mode (M2), the seat surface portion (21) of the one seat (20) is accommodated in the concave portion (BP1) so as to be flush with the wall (BP). With such a configuration, when the seating surface portion (21) of the wall seat (20) is in the non-face-to-face mode (M2), the seating surface portion (21) can be accommodated with a good appearance of being integral with the wall (BP) of the vehicle and in a compact form with no protrusion.

In the face-to-face mode (M1), a bottom surface of the concave portion (BP1) serves as a backrest surface (BP2) that faces the front-rear direction and extends in an erected form from the seat surface portion (21) of the one seat (20). With such a configuration, when the seat surface portion (21) of the wall seat (20) is in the face-to-face mode (M1), the bottom surface of the concave portion (BP1) that accommodates the seat surface portion (21) can rationally function as the backrest surface (BP2) of the occupant seated on the seat surface portion (21).

### Second Embodiment

(General Configuration of Seat Structure)

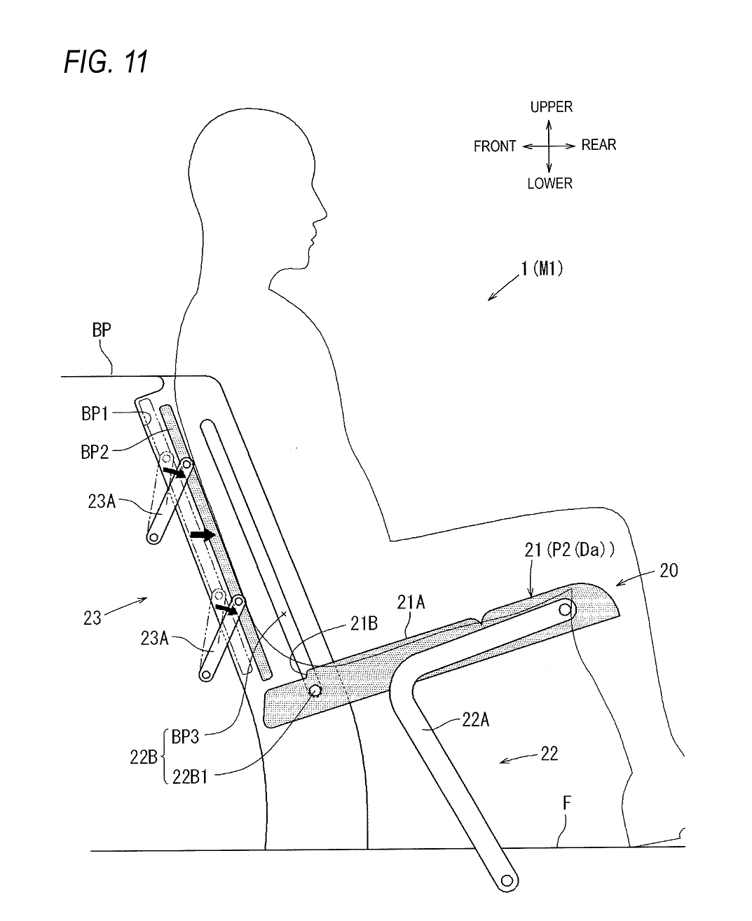

Next, a seat structure according to a second embodiment is described with reference to FIG. 11. In this embodiment, an extrusion mechanism 23 is provided to separate a panel element serving as the backrest surface BP2 from the instrument panel BP and to extrude the panel element rearward in accordance with unfolding a seat surface portion into the horizontal posture P2 relative to the instrument panel seat 20 or after the seat surface portion is unfolded into the horizontal posture P2.

The extrusion mechanism 23 includes a total of four push and pull links 23A, that is, a pair of front and rear push and pull links 23A and a pair of left and right push and pull links 23A, that connect the panel element serving as the backrest surface BP2 and a vehicle body panel (not illustrated) covered by the panel element. The extrusion mechanism 23 is operated to push out the panel element serving as the backrest surface BP2 rearward from an initial position of serving as an inner surface of a concave portion via drive control by an electric unit (not illustrated) connected to one of the push links 23A.

As described above, the panel element serving as the backrest surface BP2 is pushed out from the initial position. Accordingly, the panel element serving as the backrest surface BP2 is separated from an internal structure such as the vehicle body panel (not illustrated) that is covered by the panel element at the initial position, and is properly deflected when a back of an occupant is leant on the backrest surface BP2, so that backrest loads by the occupant is received more elastically. Configurations other than the above are the same as those of the seat structure 1 described in the first embodiment, and the same reference numerals are attached to these configurations. Accordingly, detailed descriptions of these configurations are omitted.

### Other Embodiments

Two embodiments for carrying out the present disclosure has been described, but the present disclosure may be carried out in various modes other than the above embodiments. For example, the configuration of the vehicle seat structure of the present disclosure may be widely applied to a seat structure used for cars other than an automobile such as a train or a vehicle such as an aircraft and a ship.

The wall seat attached to the wall of the vehicle may be attached to a wall of a vehicle having no instrument panel as long as the wall faces the other seat in the front-rear direction. Further, various operation mechanisms such as the mode switching mechanism, the sliding mechanism, and the seat surface angle adjusting mechanism may be driven and controlled by an electric unit, and may be operated by manual operation or by a biasing action of a spring accompanying lock release.

The seating surface portion of the wall seat may be pulled out from the concave portion in the wall in a straight sliding manner and unfolded into a use state. Further, the seating surface portion of the wall seat may be inclined from the concave portion by being rotated about a single shaft for the occupant to be seated on an upper surface thereof. The mode switching mechanism and the seat surface angle adjusting mechanism may be separate mechanisms. Further, the non-face-to-face mode in which the face-to-face mode is released may be a mode in which the wall seat is accommodated in a manner incapable of being leaned on in an upright posture.

The disclosure provides illustrative, non-limiting examples as follows:

A first aspect of the disclosure provides a vehicle seat structure including a mode switching mechanism configured to switch configurations of two seats arranged in a front-rear direction between a face-to-face mode in which seated occupants are seated on the seats to face each other in the front-rear direction and a non-face-to-face mode in which the face-to-face mode is released, wherein one seat of the two seats is a wall seat attached to a wall of a vehicle which faces another seat of the two seats in the front-rear direction, and is configured to be switched, by the mode switching mechanism, between the non-face-to-face mode in which a seat surface portion of the one seat is accommodated in a concave portion in the wall and the face-to-face mode in which the seat surface portion of the one seat is pulled out from the concave portion so as to be capable of being seated on.

According to the first aspect of the disclosure, the one seat that constitutes the face-to-face mode is the wall seat attached to the wall of the vehicle, and the seat surface portion of the same wall seat is accommodated in the concave portion of the wall by the mode switching mechanism when the one seat is in the non-face-to-face mode. Therefore, the interior space can be widened when the one seat is not in the face-to-face mode.

A second aspect of the disclosure provides the vehicle seat structure according to the first aspect, further including: a slide mechanism configured to adjust a position of the other seat relative to a vehicle body in the front-rear direction.

According to the second aspect of the disclosure, a face-to-face distance between the wall seat and the other seat can be appropriately adjusted by the slide mechanism. Besides, the other seat can be brought close to the wall seat to expand a function of using the seat surface portion of the wall seat as a footrest.

A third aspect of the disclosure provides the vehicle seat structure according to the first or second aspect, further including: a seat surface angle adjusting mechanism configured to switch a seat surface angle of the seat surface portion of the one seat in the face-to-face mode to an angle at which a forward inclined surface is formed and an angle at which a rearward inclined surface is formed.

According to the third aspect of the disclosure, the seat surface angle of the seat surface portion in the face-to-face mode can be adjusted by the seat surface angle adjusting mechanism. Besides, in a case in which the seat surface portion is used as the footrest, the seat surface angle can be switched, as an expanded function, between an inclined surface angle inclined toward one side appropriate for placing soles and an inclined surface angle inclined to another side appropriate for placing heels.

A fourth aspect of the disclosure provides the vehicle seat structure according to any one of the first to third aspects; wherein, in the non-face-to-face mode, the seat surface portion of the one seat is accommodated in the concave portion so as to be flush with the wall.

According to the fourth aspect of the disclosure, when the seating surface portion of the wall seat is in the non-face-to-face mode, the seating surface portion can be accommodated with a good appearance of being integral with the wall of the vehicle and in a compact form with no protrusion.

A fifth aspect of the disclosure provides the vehicle seat structure according to any one of the first to fourth aspects, wherein, in the face-to-face mode, a bottom surface of the concave portion serves as a backrest surface that faces the front-rear direction and extends in an erected form from the seat surface portion of the one seat.

According to the fifth aspect of the disclosure, when the seat surface portion of the wall seat is in the face-to-face mode, the bottom surface of the concave portion that accommodates the seat surface portion can rationally function as the backrest surface of the occupant seated on the seat surface portion.

What is claimed is:

1. A vehicle seat structure comprising:
a mode switching mechanism configured to switch configurations of two seats arranged in a front-rear direction between a face-to-face mode in which seated occupants are seated on the seats to face each other in the front-rear direction and a non-face-to-face mode in which the face-to-face mode is released,
wherein one seat of the two seats is a wall seat attached to a wall of a vehicle which faces another seat of the two seats in the front-rear direction, and is configured to be switched, by the mode switching mechanism, between the non-face-to-face mode in which a seat surface portion of the one seat is accommodated in a concave portion in the wall and the face-to-face mode in which the seat surface portion of the one seat is pulled out from the concave portion so as to be capable of being seated on.

2. The vehicle seat structure according to claim 1, further comprising:
a slide mechanism configured to adjust a position of the other seat relative to a vehicle body in the front-rear direction.

3. The vehicle seat structure according to claim 1, further comprising:
a seat surface angle adjusting mechanism configured to switch a seat surface angle of the seat surface portion of the one seat in the face-to-face mode to an angle at which a forward inclined surface is formed and an angle at which a rearward inclined surface is formed.

4. The vehicle seat structure according to claim 1,
wherein, in the non-face-to-face mode, the seat surface portion of the one seat is accommodated in the concave portion so as to be flush with the wall.

5. The vehicle seat structure according to claim 1,
wherein, in the face-to-face mode, a bottom surface of the concave portion serves as a backrest surface that faces the front-rear direction and extends in an erected form from the seat surface portion of the one seat.
